(19) United States
(12) Patent Application Publication
(10) Pub. No.: US 2024/0401981 A1
(43) Pub. Date: Dec. 5, 2024

(54) ESTIMATION APPARATUS, ESTIMATION METHOD, AND COMPUTER READABLE MEDIUM

(71) Applicant: Asahi Kasei Microdevices Corporation, Tokyo (JP)

(72) Inventors: Takumu YOMOGITA, Tokyo (JP); Toshimasa SUZUKI, Tokyo (JP)

(21) Appl. No.: 18/597,883

(22) Filed: Mar. 6, 2024

(30) Foreign Application Priority Data
May 29, 2023 (JP) 2023-088107
Jan. 18, 2024 (JP) 2024-005749

(51) Int. Cl. G01D 5/14; G01B 7/30; G01C 19/00

(52) U.S. Cl. CPC G01D 5/145; G01B 7/30; G01C 19/00

(57) ABSTRACT

An estimation apparatus which estimates at least one of a position or a posture of a second portion relative to a first portion includes a derivation unit which derives a difference between a first value based on a first measured value according to a position or a posture of the second portion relative to the first portion measured by the magnetic sensor and a second value based on a second measured value according to a position or a posture of the second portion relative to the first portion measured by the gyro sensor; and an estimation unit which estimates a position and a posture of the second portion relative to the first portion based on at least one of the first value or the second value and the difference.

The contents of the following patent application(s) are incorporated herein by reference:
NO. 2023-088107 filed in JP on May 29, 2023
NO. 2024-005749 filed in JP on Jan. 18, 2024

### BACKGROUND

### 1. Technical Field

The present invention relates to an estimation apparatus, an estimation method, and a computer readable medium.

### 2. Related Art

Patent Document 1 describes that a bend angle is identified based on at least one of a first angle or a second angle based on the first angle and a first indicator associated with a state of the first angle based on a motion sensor and the second angle and a second index associated with a state of the second angle based on a magnetic sensor. Patent Document 2 describes a method to determine an angle by using a motion sensor and a magnetic sensor, wherein when the angle is in a predetermined dead band, the angle is determined by using the motion sensor.

### PRIOR ART DOCUMENT

### Patent Document

Patent Document 1: U.S. Pat. No. 11,300,995 specification
Patent Document 2: WO 2021/101171

### BRIEF DESCRIPTION OF THE DRAWINGS

FIG. 1 shows an exemplary perspective view of an appearance of a folding terminal.

FIG. 2 shows an exemplary perspective view of an appearance of the folding terminal with its first portion and second portion being in a folded state.

FIG. 3 shows an exemplary perspective view of an appearance of the folding terminal with its first portion and second portion being in an unfolded state.

FIG. 4 schematically shows a circuit configuration of the folding terminal.

FIG. 5 shows an exemplary functional block of an estimation apparatus.

FIG. 6 shows an exemplary reference table showing a relationship between the strength of a magnetic field and an angle formed by the first portion and the second portion.

FIG. 7 shows a diagram to describe an integration error of the angle based on a measured value of a gyro sensor.

FIG. 8 shows a diagram to describe angle estimation by an acceleration sensor.

FIG. 9 shows a diagram to describe angle estimation by the acceleration sensor.

FIG. 10 shows temporal variation of a sensor used for estimation by the estimation unit.

FIG. 11A shows exemplary temporal variations of an expected value of an angle when the estimation of the angle is performed only by a magnetic sensor, and an angle of an estimation result.

FIG. 11B shows an exemplary temporal variation of an angular error between the expected value and the angle of the estimation result in FIG. 11A.

FIG. 12A shows exemplary temporal variations of an expected value of an angle and an angle estimated by the estimation unit according to the present embodiment.

FIG. 12B shows an exemplary temporal variation of an angular error between the expected value and the angle of the estimation result in FIG. 12A.

FIG. 13 is a flowchart showing an exemplary procedure performed by the estimation unit for estimating an angle.

FIG. 14 is a flowchart showing another exemplary procedure performed by a derivation unit for deriving a difference.

FIG. 15 is a flowchart showing another exemplary procedure performed by the derivation unit for deriving a difference.

FIG. 16 is a flowchart showing another exemplary procedure performed by the estimation unit for estimating an angle.

FIG. 17 is a flowchart showing another exemplary procedure performed by the estimation unit for estimating an angle.

FIG. 18A shows an apparatus in a contracted state for which the estimation unit estimates a position of the second portion relative to the first portion.

FIG. 18B shows the apparatus in an extended state for which the estimation unit estimates the position of the second portion relative to the first portion.

FIG. 19 shows an exemplary hardware configuration.

### DESCRIPTION OF EXEMPLARY EMBODIMENTS

Hereinafter, embodiments of the present invention will be described. However, the following embodiments are not for limiting the invention according to the claims. In addition, not all combinations of features described in the embodiment are essential to the solution of the invention.

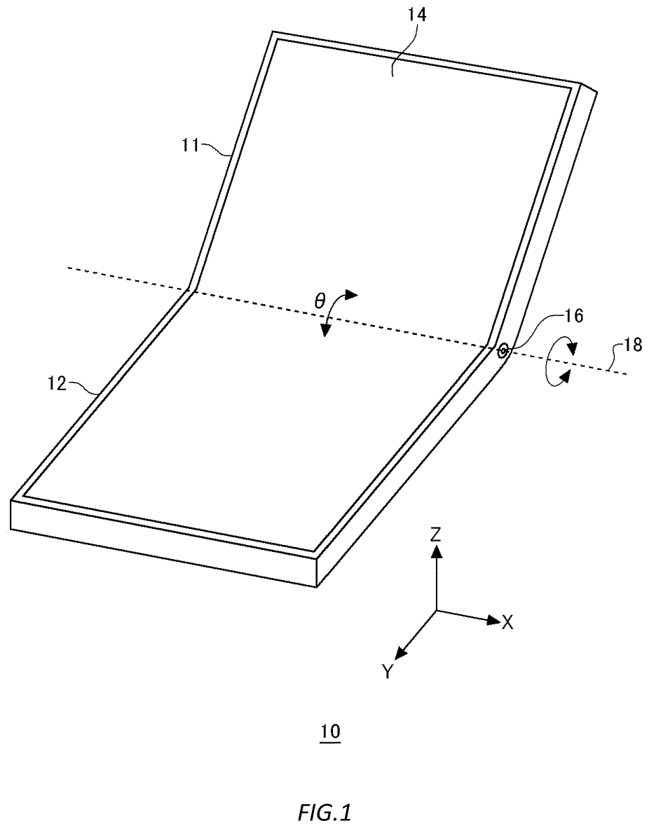

FIG. 1 shows an exemplary perspective view of an appearance of a folding terminal 10. The folding terminal 10 may be a mobile terminal such as a smartphone, a mobile phone, a tablet, a notebook computer, and a compact computer. The folding terminal 10 includes a bendable display 14. The display 14 may be an organic EL display.

The folding terminal 10 includes a first portion 11, a second portion 12 and a hinge mechanism 16. The hinge mechanism 16 foldably couples the first portion 11 to the second portion 12. The hinge mechanism 16 rotatably couples the first portion 11 to the second portion 12 around a rotation axis 18 along an X axis. The first portion 11 and the second portion 12 are parts of a casing of the folding terminal 10. The first portion 11 and the second portion 12 may be integrally configured. By the first portion 11 being transitioned from a folded state to an unfolded state relative to the second portion 12, an angle θ formed by the first portion 11 and the second portion 12 varies from 0 degrees to 180 degrees.

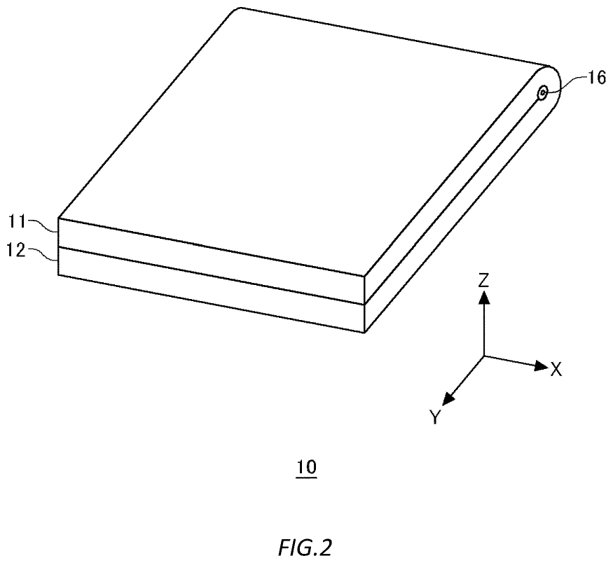

FIG. 2 shows an exemplary perspective view of an appearance of the folding terminal 10 with its first portion 11 and second portion 12 being in a folded state. That is, a state in which the angle formed by the first portion 11 and the second portion 12 is zero degrees, and in which the first portion 11 is in a closed state relative to the second portion 12 is shown.

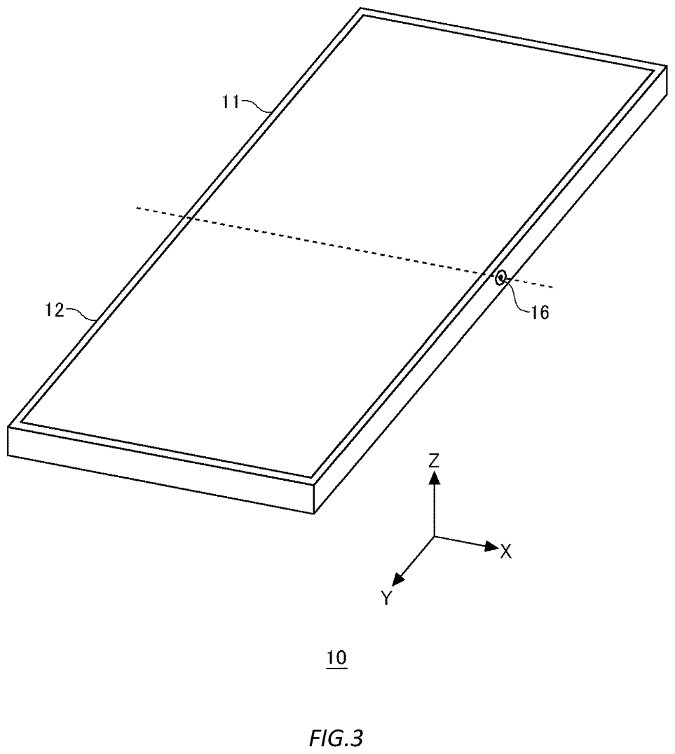

FIG. 3 shows an exemplary perspective view of an appearance of the folding terminal 10 with its first portion 11 and second portion 12 being in an unfolded state. That is, a state in which the angle formed by the first portion 11 and the second portion 12 is 180 degrees, and in which the first portion 11 is in an open state relative to the second portion 12 is shown.

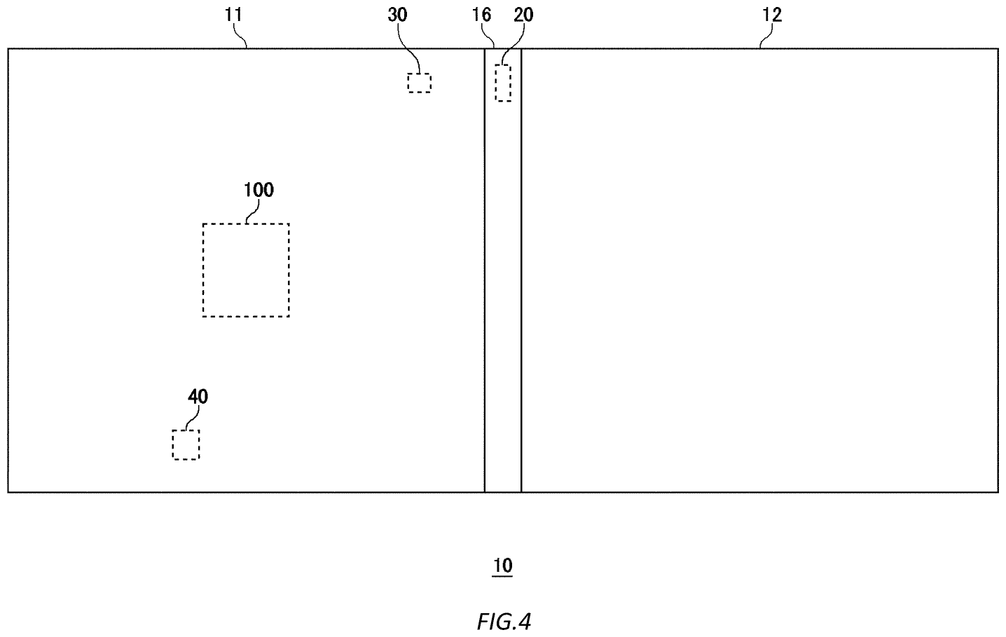

FIG. 4 schematically shows a circuit configuration of the folding terminal 10. The folding terminal 10 includes a magnet unit 20, a magnetic sensor 30, a gyro sensor 40, and an estimation apparatus 100. The magnetic sensor 30, the estimation apparatus 100, and the gyro sensor 40 are provided in the first portion 11. The magnet unit 20 is provided in the hinge mechanism 16. The hinge mechanism 16 may partially constitute at least one of the first portion 11 or the second portion 12. The magnet unit 20 may be provided in the second portion 12. At least one of the magnetic sensor 30, the gyro sensor 40, or the estimation apparatus 100 may be provided in the second portion 12. The magnetic sensor 30 may be provided in the hinge mechanism 16 and the magnet unit 20 may be provided in the first portion 11 or the second portion 12. The magnetic sensor 30 may be provided in one of the first portion 11 or the second portion 12, and the gyro sensor 40 may be provided in another of the first portion 11 or the second portion 12. Note that, the arrangement of the magnet unit 20, the magnetic sensor 30, the gyro sensor 40 and the estimation apparatus 100 is not limited to the above descriptions. The magnet unit 20, the magnetic sensor 30, the gyro sensor 40, and the estimation apparatus 100 may be arranged in any position as long as the estimation apparatus 100 can estimate the angle formed by the first portion 11 and the second portion 12.

The magnetic sensor 30 detects the strength of the magnetic fields (magnetic flux density) in three axis directions (X axis, Y axis, and Z axis). The magnetic sensor 30 outputs voltage or current according to the strength of the magnetic field. The magnetic sensor 30 may be a Hall element. When the first portion 11 is being folded relative to the second portion 12, a positional relationship between the magnetic sensor 30 and the magnet unit 20 varies, and thus the strength of the magnetic field of the magnet unit 20 to be detected by the magnetic sensor 30 varies. That is, depending on the angle formed by the first portion 11 and the second portion 12, the strength of the magnetic field to be detected by the magnetic sensor 30 varies. The gyro sensor 40 detects an angular velocity of the folding terminal 10 around the axes along the X axis, the Y axis, and the Z axis. The folding terminal 10 may include an inertial measurement unit (IMU) that functions as the gyro sensor 40. The IMU detects the angular velocity of the folding terminal 10 around the axes along the X axis, Y axis, and Z axis as well as acceleration of the folding terminal 10 in the directions of the X axis, Y axis, and Z axis of the folding terminal 10.

The estimation apparatus 100 estimates the positional relationship between the first portion 11 and the second portion 12 based on at least one of the strength of the magnetic field (magnetic flux density) detected by the magnetic sensor 30 or the angular velocity detected by the gyro sensor 40. The estimation apparatus 100 estimates the angle formed by the first portion 11 and the second portion 12 based on at least one of the strength of the magnetic field (magnetic flux density) detected by the magnetic sensor 30 or the angular velocity detected by the gyro sensor 40.

The folding terminal 10 may perform a predetermined operation based on the angle estimated by the estimation apparatus 100. The folding terminal 10 may display different images on a display section of the first portion 11 and a display section of the second portion 12 based on the angle estimated by the estimation apparatus 100. For example, if the angle estimated by the estimation apparatus 100 is included in a predetermined angular range such as from 90 degrees to 120 degrees, the folding terminal 10 may display, on the display section of the second portion 12, the operational functionality such as a keyboard or the like and may display, on the display section of the first portion 11, the display functionality to display images according to contents of the operations performed by the operational functionality, for example, documents, videos, or the like.

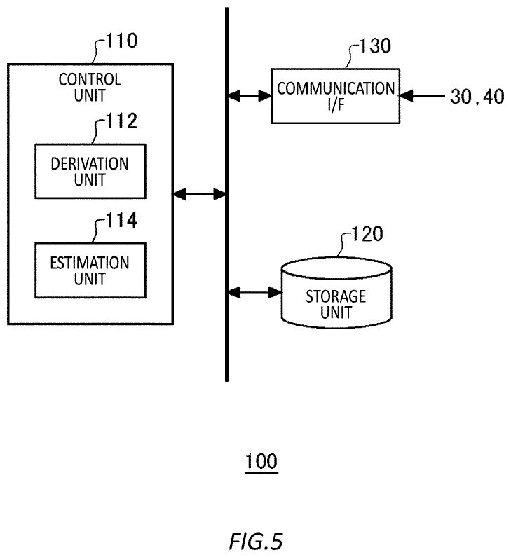

FIG. 5 shows an exemplary functional block of the estimation apparatus 100. The estimation apparatus 100 includes a control unit 110, a storage unit 120 and a communication I/F 130. The control unit 110 may be configured by a microprocessor such as a CPU or an MPU, or by a microcontroller such as an MCU or the like. The control unit 110 may be configured by a system-on-chip (SoC). The storage unit 120 may be a computer readable recording medium, and it may include at least one of SRAM, DRAM, EPROM, EEPROM (registered trademark) or a flash memory such as a USB memory. The communication I/F 130 is an interface to communicate with the magnetic sensor 30 and the gyro sensor 40.

The control unit 110 includes a derivation unit 112 and an estimation unit 114. Here, it is considered that the estimation unit 114 estimates the angle formed by the first portion 11 and the second portion 12 based on relationship information indicating the relationship between the angle θ formed by the second portion 12 relative to the first portion 11 and the strength of the magnetic field as well as the output result of the magnetic sensor 30.

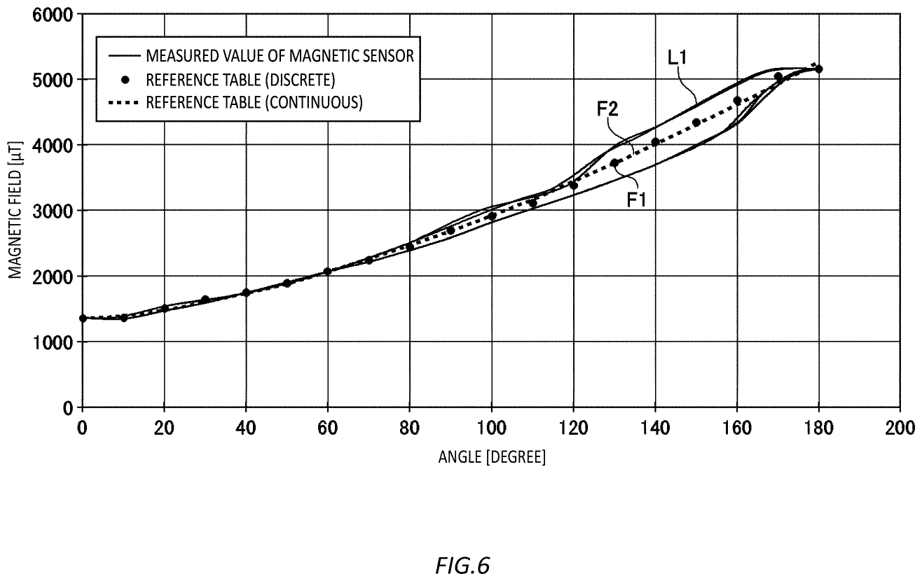

As shown in FIG. 6, for example, the relationship information may be a reference table (discrete) F1 indicating the relationship between the strength of the magnetic field and the angle θ formed by the first portion 11 and the second portion 12, or may be a reference table (continuous) F2 expressed in a predetermined polynomial. The relationship information may be, for example, information indicating a function representing the angle θ according to the strength of the magnetic field. The relationship information may be information to show an nth-degree polynomial (n is a positive integer) that has the strength of the magnetic field and the angle θ as variables. The relationship information may be the information to show a 3rd-degree polynomial that has the strength of the magnetic field and the angle θ as variables. The 3rd-degree polynomial may be expressed as Y=aX³+bX²+cX+d. X represents the angle θ, and Y represents the strength of the magnetic field. a, b, c, and d are constants. The relationship information may be previously stored in the storage unit 120. The relationship information may be generated according to the test results before the folding terminal 10 is shipped.

However, actual measured values measured by the magnetic sensor 30 may, as shown by the solid line L1, exhibit different relationships of the strength of the magnetic field and the angle θ formed by the first portion 11 and second portion 12 between a case in which the first portion 11 and the second portion 12 transition from the folded state to the unfolded state and a case in which the first portion 11 and the second portion 12 transition from the unfolded state to the folded state. That is, the relationship between the strength of the magnetic field and the angle θ formed by the first portion 11 and the second portion 12 may include hysteresis. The hysteresis may be caused by the influence of a magnetic hysteresis. In addition, the positional relationship between the magnet unit 20 and the magnetic sensor 30 may change subtly depending on how much force is applied on the hinge when the folding terminal 10 is opened and/or closed. This influence may also appear as hysteresis in the strength of the magnetic field measured by the magnetic sensor 30. Accordingly, the estimation unit 114 may not be able to estimate the angle θ formed by the first portion 11 and the second portion 12 accurately based only on the reference table (discrete) F1 or the reference table (continuous) F2 as shown in FIG. 6.

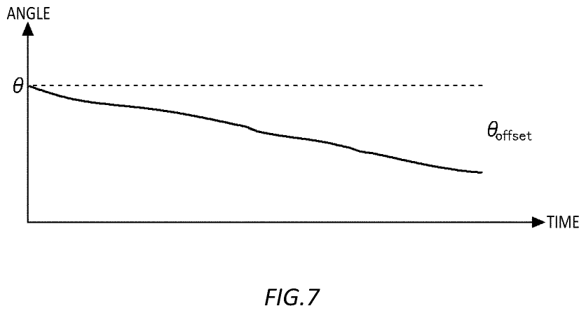

In addition, it is considered that the estimation unit 114 estimates the angle θ formed by the second portion 12 relative to the first portion 11 based on the measured value measured by the gyro sensor 40. A measured value measured by the gyro sensor 40 is an angular velocity. When the measured value measured by the gyro sensor 40 is used, it is considered that the estimation unit 114 estimates the angle formed by the first portion 11 and the second portion 12 by integrating the angular velocity to derive a relative angle variation amount and adding the angle variation amount to the last estimated angle. However, errors are accumulated by integrating the angular velocity. Accordingly, as shown in FIG. 7, the error θ_{offset} is increased in proportion to the time elapsed since the start of estimation by the estimation unit 114. That is, estimation of the angle using the measured values measured by the gyro sensor 40 may undergo a decrease in accuracy due to the elapse of time since the start of estimation by the estimation unit 114. Note that, in the example shown in FIG. 7, the error θ_{offset} is increased in a minus direction in proportion to the time elapsed since the start of estimation by the estimation unit 114. However, the error θ_{offset} may be increased in a plus direction.

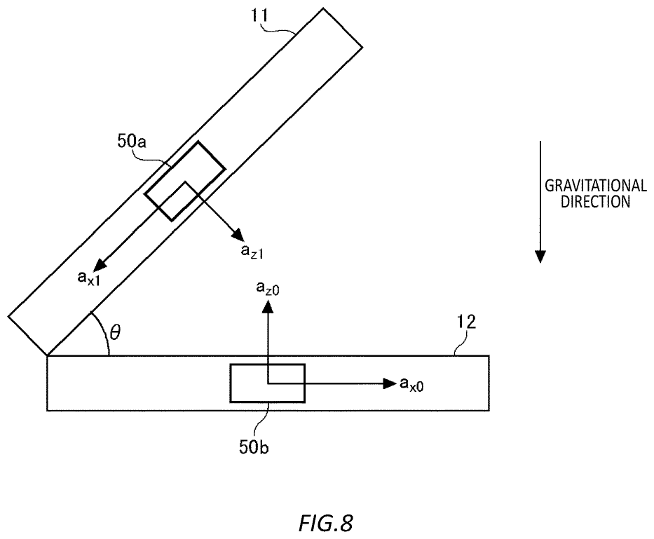

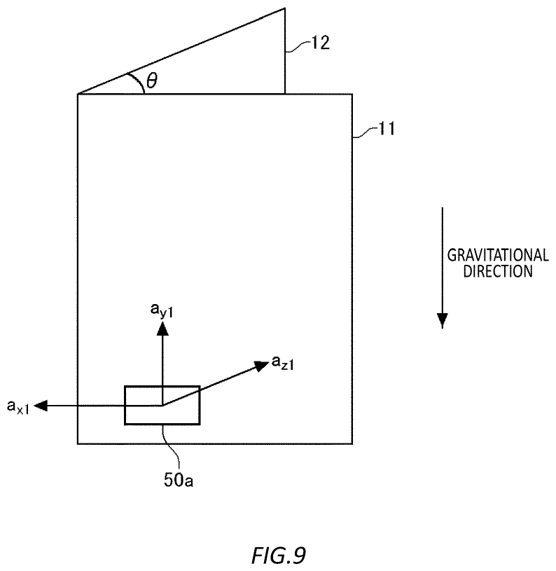

Moreover, when the folding terminal 10 includes two acceleration sensors 50a and 50b, it is considered that the estimation unit 114 estimates the angle formed by the first portion 11 and the second portion 12 by deriving an absolute angle based on an angle formed by acceleration vectors measured by each of the two acceleration sensors. In this approach, if the acceleration vectors measured by the two acceleration sensors have components in different gravitational directions with each other as shown in FIG. 8, the estimation unit 114 can estimate the angle formed by the first portion 11 and the second portion 12. However, as shown in FIG. 9, depending on postures of the first portion 11 and the second portion 12, the acceleration vectors measured by the two acceleration sensors 50a, 50b may not have components in the different gravitational directions with each other. In this case, the estimation unit 114 cannot estimate the angle formed by the first portion 11 and the second portion 12.

As described above, the angle formed by the first portion 11 and the second portion 12 may not be accurately estimated with each of the magnetic sensor 30, gyro sensor 40, and acceleration sensor 50a, 50b.

Therefore, in the present embodiment, the estimation unit 114 estimates more accurately the posture of the second portion 12 relative to the first portion 11, or in other words, the angle formed by the first portion 11 and the second portion 12, based on at least one of the measured value m (μT) measured by the magnetic sensor 30 or the measured value ω_{g} (rad/s) measured by the gyro sensor 40.

Here, as described above, the relationship between the measured value m of the magnetic sensor 30 and the angle θ formed by the second portion 12 relative to the first portion 11 may include hysteresis. However, the angles that include hysteresis is often a part of an angular range. In an angular range which does not include the hysteresis, the estimation unit 114 is likely to be able to accurately estimate the angle θ formed by the first portion 11 and the second portion 12 based on the measured value m of the magnetic sensor 30.

In addition, when the measured value ω_{g} of the gyro sensor 40 is used, the estimation unit 114 will be estimating the angle θ formed by the second portion 12 relative to the first portion 11 by adding the angle variation amount Δθ_{g} based on the current measured value ω_{g} to the last angle θₜ₋₁ which is the estimation result obtained last time. That is, if the angle is estimated using the measured value ω_{g} measured by the gyro sensor 40 before a long time elapses after the estimation unit 114 estimated the angle relatively accurately, the error in the integration becomes less. Accordingly, if a long time has not elapsed, the estimation unit 114 is likely to be able to accurately estimate the angle θ formed by the first portion 11 and the second portion 12.

Therefore, the estimation unit 114 estimates the angle θ formed by the first portion 11 and the second portion 12 by preferentially using the measured value m of the magnetic sensor 30 in the angular range which does not include the hysteresis. Meanwhile, the estimation unit 114 estimates the angle θ formed by the second portion 12 relative to the first portion 11 by preferentially using the measured value ω_{g} of the gyro sensor 40 in the angular range which includes the hysteresis.

In order to determine whether the opened/closed state of the folding terminal 10 is in the angular range including the hysteresis, the derivation unit 112 derives the difference diff between the measured value m according to the posture of the second portion 12 relative to the first portion 11 measured by the magnetic sensor 30 and the measured value ω_{g} according to the posture of the second portion 12 relative to the first portion 11 measured by the gyro sensor 40.

The derivation unit 112 converts a unit of the measured value m and a unit of the measured value ω_{g} into a common unit, and then derives the difference diff between the measured value m and the measured value ω_{g}. Values in the common unit after conversion of the measured value m and the measured value ω_{g} are examples of the first value based on the measured value m and the second value based on the measured value ω_{g}. The unit is the angle (degree), the magnetic flux density (strength of the magnetic field) (μT), the angle variation amount (degree), the magnetic flux density variation amount (μT/s), the angular velocity (rag/s), or the angular velocity (degree/s). Here, the angle (degree) refers to the angle formed by the first portion 11 and the second portion 12, that is, the absolute angle. The angle variation amount (degree) refers to the angle indicating the difference between the last angle formed by the first portion 11 and the second portion 12 and the current angle formed by the first portion 11 and the second portion 12, that is, the relative angle.

The estimation unit 114 estimates the posture of the second portion 12 relative to the first portion 11, or in other words, the angle θ formed by the second portion 12 relative to the first portion 11, based on at least one of the measured value m or the measured value ω_{g}, and the difference diff. The estimation unit 114 selects at least one of the measured value m or the measured value ω_{g} based on the difference diff, and estimates the posture of the second portion 12 relative to the first portion 11 based on the selected at least one of the measured value m or the measured value ω_{g}.

If the measured value ω_{g} used for estimation by the estimation unit 114 is the one measured by the gyro sensor 40 before a long time elapses, the estimation unit 114 can accurately estimate the posture of the second portion 12 relative to the first portion 11 based on the measured value ω_{g}. In an angular range not including the hysteresis, the estimation unit 114 can accurately estimate the posture of the second portion 12 relative to the first portion 11 based on the measured value m of the magnetic sensor 30. Accordingly, the magnitude of the difference diff decreases. On the other hand, in an angular range including the hysteresis, the estimation unit 114 cannot accurately estimate the posture based on the measured value m of the magnetic sensor 30. Accordingly, the magnitude of the difference diff increases. Given the above description, the difference diff corresponds to the magnitude of the magnetic field hysteresis. Thus, the larger the difference diff is, the more likely the opened/closed state of the folding terminal 10 is in the angular range including the hysteresis. Therefore, if the difference diff is smaller than a threshold th, the estimation unit 114 may estimate the posture of the second portion relative to the first portion 11 based on the measured value m of the magnetic sensor 30. If the difference diff is smaller than the threshold th, the estimation unit 114 may estimate the posture of the second portion 12 relative to the first portion 11 based on the measured value m at the estimation time point and the relationship information (reference table), as shown in FIG. 6, indicating the relationship between the measured value m measured by the magnetic sensor 30 and the posture (angle) of the second portion 12 relative to the first portion 11.

If the difference diff is equal to or more than the threshold th, the estimation unit 114 may estimate the posture of the second portion 12 relative to the first portion 11 based on the measured value ω_{g} of the gyro sensor 40. If the difference diff is equal to or more than the threshold th, the estimation unit 114 may estimate the posture of the second portion 12 relative to the first portion 11 based on the last estimation result and the measured value ω_{g}.

The estimation unit 114 may estimate the posture of the second portion 12 relative to the first portion 11 based on the measured value m having the first weight based on the difference diff and the measured value ω_{g} having the second weight based on the difference diff. As the difference diff becomes larger, the first weight decreases and the second weight increases correspondingly. The estimation unit 114 may derive the weight according to a predetermined function f (diff) having the difference diff as a parameter. The estimation unit 114 may be implemented by Kalman filter. In this case, the Kalman gain corresponds to the weight.

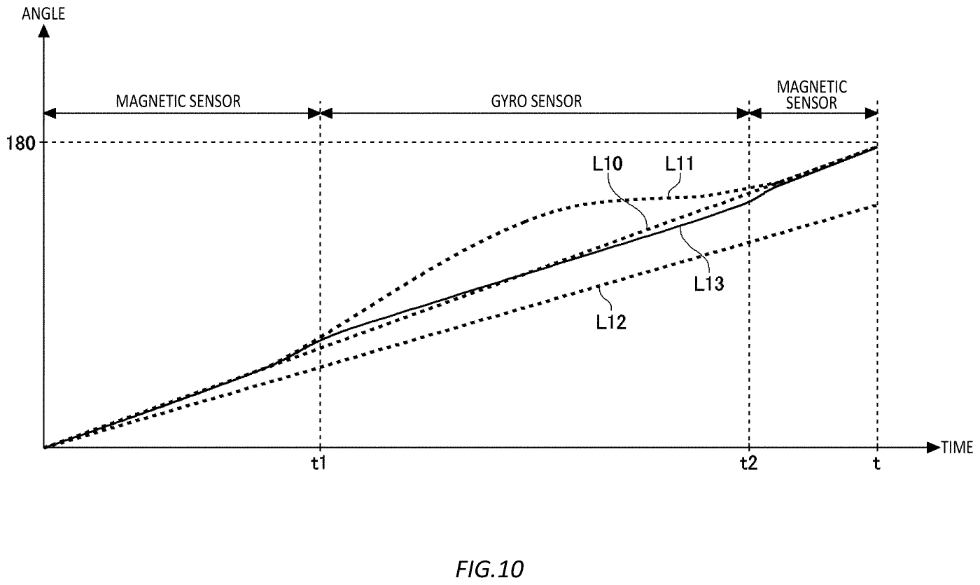

FIG. 10 shows temporal variation of a sensor used for estimation by the estimation unit 114 when the second portion 12 is rotated relative to the first portion 11 from the closed state to the opened state of the folding terminal 10. The dashed line L11 shows temporal variation of the angle estimated based on the measured value m of the magnetic sensor 30. The dashed line L12 shows temporal variation of the angle estimated based on the integral value of the measured value ω_{g} of the gyro sensor 40. The dashed line L10 shows temporal variation of the actual angle of the second portion 12 relative to the first portion 11. The solid line L13 shows temporal variation of the angle corresponding to the estimation result obtained when the estimation unit 114 switches the sensors to be used for estimation depending on the difference diff.

The difference diff remains smaller than the threshold th until time t1 is reached after the folding terminal 10 in the closed state started opening. That is, the influence of hysteresis is small. Thus, the estimation unit 114 estimates the angle of the second portion 12 relative to the first portion 11 by referring to the reference table to determine the angle θₘ that corresponds to the measured value m of the magnetic sensor 30. After time t1 is passed, the difference diff becomes equal to or more than the threshold th. Thus, the estimation unit 114 estimates the angle of the second portion 12 relative to the first portion 11 by adding the current angle variation amount Δθₜ measured by the gyro sensor 40 to the last angle θₜ₋₁, which is the last estimation result, to derive the current angle θ_{g}. Subsequently, when time t2 is reached, the difference diff becomes smaller than threshold th again. Thus, the estimation unit 114 estimates the angle of the second portion 12 relative to the first portion 11 by referring to the reference table again to determine the angle θₘ that corresponds to the measured value m of the magnetic sensor 30. In this manner, when the estimation unit 114 switches the sensors to be used for the estimation depending on the difference diff, the angle of the second portion 12 relative to the first portion 11 can be more accurately estimated as compared to when only the magnetic sensor 30 is used or when only the gyro sensor 40 is used.

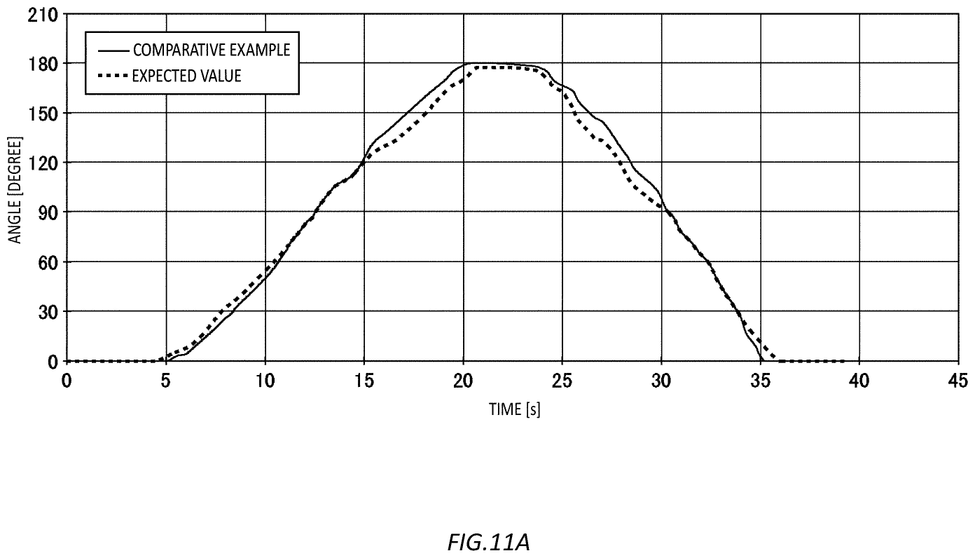

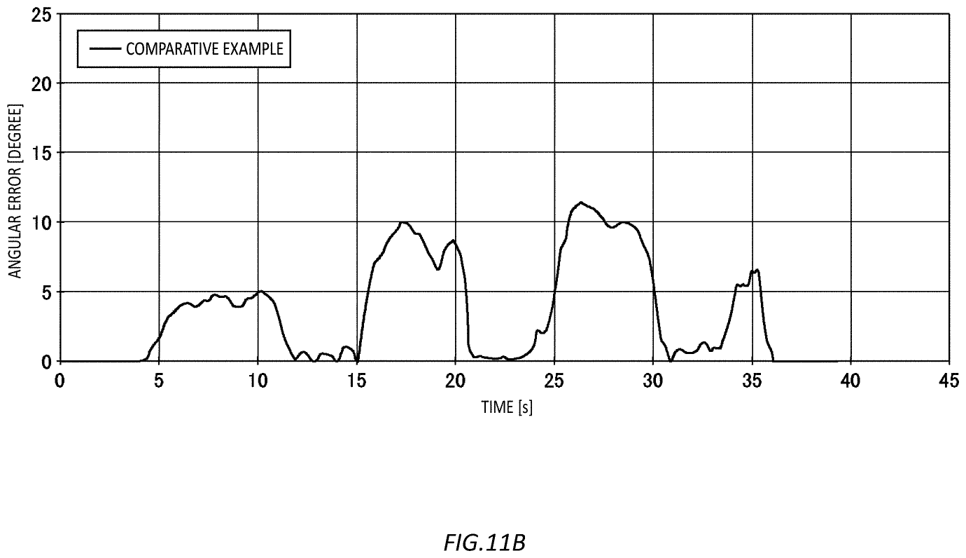

FIG. 11A and FIG. 11B show exemplary simulation results when the estimation unit 114 estimates the angle of the second portion 12 relative to the first portion 11 using the magnetic sensor 30 only. FIG. 11A shows temporal variations of an expected value of an angle to be estimated by the estimation unit 114, and an angle estimated by the estimation unit 114. FIG. 11B shows a temporal variation of an angular error between the expected value and the estimated angle.

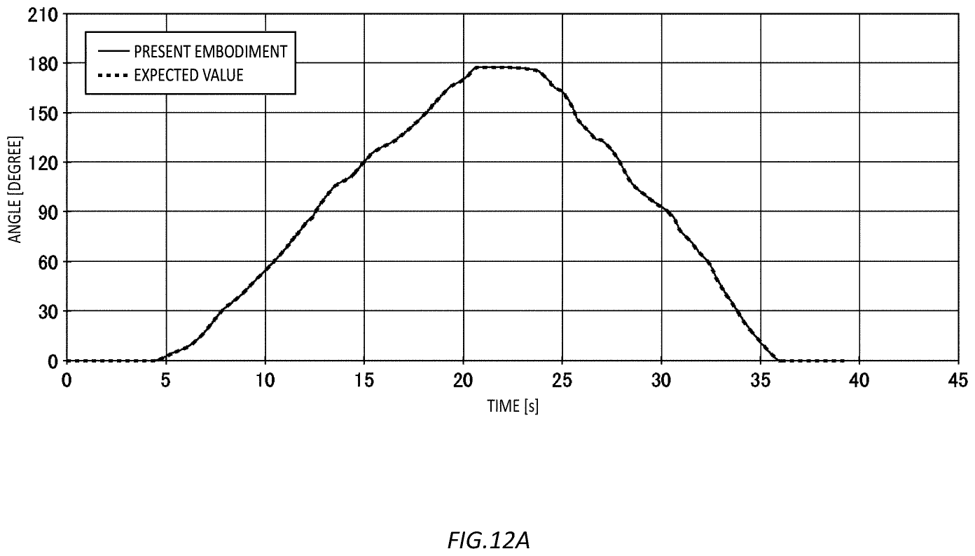

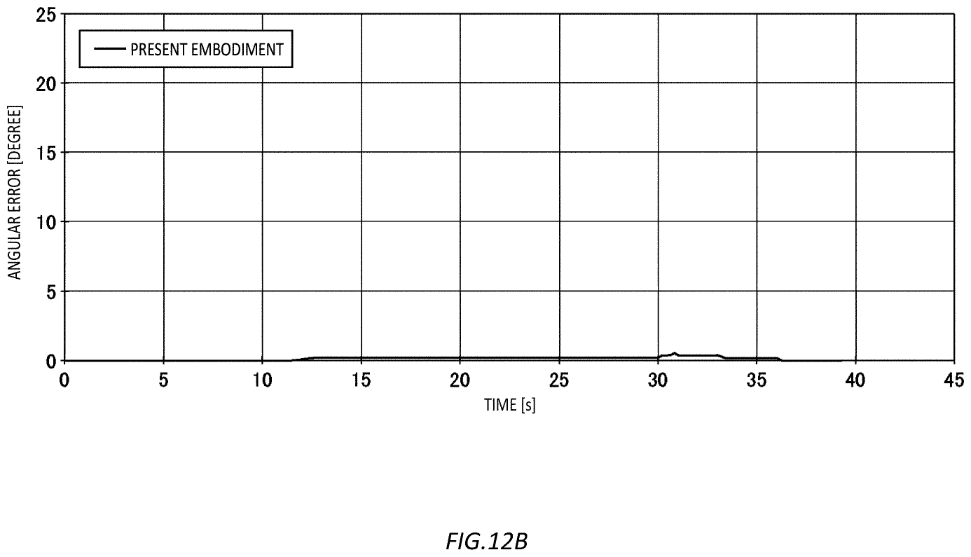

FIG. 12A and FIG. 12B show exemplary simulation results when the estimation unit 114 switches the sensors used for estimation depending on the difference diff in estimating the angle of the second portion 12 relative to the first portion 11. FIG. 12A shows temporal variations of an expected value of an angle to be estimated by the estimation unit 114 and an angle estimated by the estimation unit 114. FIG. 12B shows a temporal variation of an angular error between the expected value and the estimated angle.

As can be seen by comparing FIG. 11B with FIG. 12B, the angular error can be suppressed by the estimation unit 114 switching the sensors to be used for estimation depending on the difference diff.

Here, if the estimation unit 114 estimates the angle of the second portion 12 relative to the first portion 11 for a long time in the angular range including the hysteresis based only on the measured value ω_{g} of the gyro sensor 40, the error of the integral value may be accumulated and the angular error may increase, again resulting in a decrease in accuracy of the estimation by the estimation unit 114.

Therefore, if the difference diff is equal to or more than the threshold th, the estimation unit 114 continues estimation of the posture of the second portion 12 relative to the first portion 11 based on the measured value ω_{g} until a predetermined period elapses from an estimation start time point at which the estimation unit 114 started estimation of the posture of the second portion 12 relative to the first portion 11 based on the measured value ω_{g} of the gyro sensor 40 when the difference diff became equal to or larger than the threshold th from a state of being smaller than the threshold th. If the difference diff remains to be equal to or more than the threshold th after the predetermined period has elapsed from the estimation start time point, the estimation unit 114 switches the estimation to the estimation of the posture of the second portion 12 relative to the first portion 11 based on the measured value m of the magnetic sensor 30. Accordingly, it is possible to prevent increase in the angular error which is caused by estimating the angle of the second portion 12 relative to the first portion 11 based only on the measured value ω_{g} of the gyro sensor 40 for a long time in the angular range including the hysteresis.

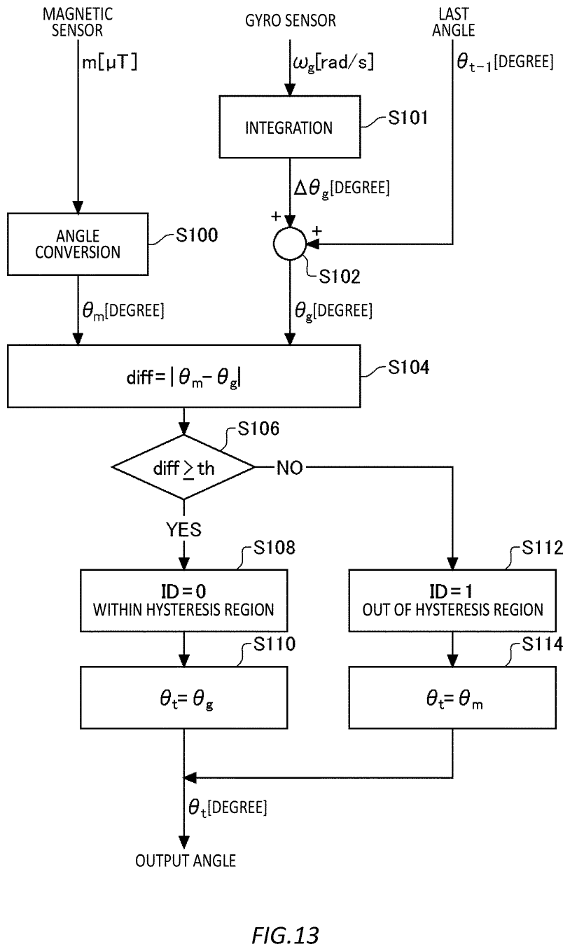

FIG. 13 is a flowchart showing an exemplary procedure performed by the estimation unit 114 for estimating an angle. The derivation unit 112 converts a measured value m (μT) of the magnetic sensor 30 from the strength of the magnetic field into an angle θₘ (degree) according to the reference table (S100). The angle θₘ is an example of the first value based on the measured value m. In addition, the angle θₘ is an example of the first value based on a value obtained by converting the measured value m into an angle. In addition, the derivation unit 112 derives an angle variation amount Δθ_{g} (degree) by integrating the measured value ω_{g} (rad/s) measured by the gyro sensor 40 (S101). The derivation unit 112 derives the angle θ_{g} (degree) based on the measured value ω_{g} (rad/s) of the gyro sensor 40 by adding, to the last angle θₜ₋₁ (degree) estimated by the estimation unit 114, an angle variation amount Δ74 _{g} (degree) obtained by integrating the measured value ω_{g} (rad/s) measured by the gyro sensor 40 (S102). The angle θ_{g} is an example of the second value based on the measured value ω_{g}. In addition, the angle θ_{g} is an example of the second value based on a value obtained by integrating the measured value ω_{g}. In addition, the angle θ_{g} is an example of the second value based on a value based on an estimation result of the estimation unit 114.

Then, the derivation unit 112 derives a difference diff between the angle θₘ and the angle θ_{g} (S104). The estimation unit 114 determines whether the difference diff is equal to or more than the threshold th (S106).

The estimation unit 114 estimates the angle θₜ of the second portion 12 relative to the first portion 11 according to θₜ=ID×θₘ+(1−ID)×θ_{g}. ID is a real number. ID×θₘ is an example of the measured value m having the first weight based on the difference diff. (1−ID)×θ_{g} is an example of the measured value ω_{g} having the second weight based on the difference diff. If the difference diff is equal to or more than the threshold th, the estimation unit 114 determines that the angle of the second portion 12 relative to the first portion 11 is within the hysteresis region, and sets ID=0 (S108). Accordingly, the estimation unit 114 estimates the angle θ_{g} based on the measured value ω_{g} of the gyro sensor 40 to be the current angle θₜ (degree) of the second portion 12 relative to the first portion 11 (S110).

If the difference diff is smaller than the threshold th, the estimation unit 114 determines that the angle of the second portion 12 relative to the first portion 11 is out of the hysteresis region, and set ID=1 (S112). Accordingly, the estimation unit 114 estimates the angle θₘ based on the measured value m of the magnetic sensor 30 to be the current angle θₜ of the second portion 12 relative to the first portion 11 (S114).

As described above, according to the above procedure, if the angle is within the hysteresis region, the estimation unit 114 estimates the angle θₜ of the second portion 12 relative to the first portion 11 using the angle θ_{g} based on the measured value ω_{g} of the gyro sensor 40. On the other hand, if the angle is out of the hysteresis region, the estimation unit 114 estimates the angle θₜ of the second portion 12 relative to the first portion 11 using the angle θₘ based on the measured value m of the magnetic sensor 30. Accordingly, the estimation unit 114 avoids the influences of the hysteresis and the integration error by reducing, by the gyro sensor, the influence caused by the hysteresis of the magnetic field, and reducing, by the magnetic sensor, the influence of the integration error of the gyro sensor, allowing accurate estimation of the angle θₜ of the second portion 12 relative to the first portion 11.

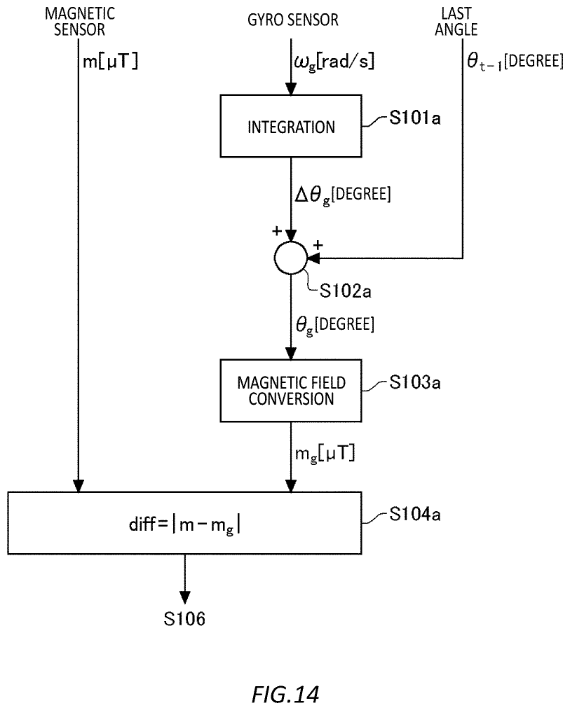

FIG. 14 is a flowchart showing another exemplary procedure performed by a derivation unit 112 for deriving a difference diff. This procedure is different from FIG. 13 as in FIG. 13 the unit of the difference diff is (degree) while in FIG. 14 the unit of the difference diff is the strength of the magnetic field (μT).

The derivation unit 112 derives an angle variation amount Δθ_{g} (degree) by integrating the measured value ω_{g} (rad/s) measured by the gyro sensor 40 (S101a). The derivation unit 112 derives the angle θ_{g} (degree) based on the measured value ω_{g} (rad/s) of the gyro sensor 40 by adding the last angle θₜ₋₁ (degree) estimated by the estimation unit 114 to an angle variation amount Δθ_{g} (degree) obtained by integrating the measured value ω_{g} (rad/s) of the gyro sensor 40 (S102a). Moreover, the derivation unit 112 converts the angle θ_{g} (degree) into the strength of the magnetic field m_{g} (μT), referring to the reference table (S103a). The strength of the magnetic field m_{g} is an example of the second value based on the measured value ω_{g}. In addition, the strength of the magnetic field m_{g} is an example of the second value based on a value obtained by integrating the measured value ω_{g}. In addition, the strength of the magnetic field m_{g} is an example of the second value based on a value based on the estimation result of the estimation unit 114. In addition, the strength of the magnetic field m_{g} is an example of the second value based on a value obtained by converting the measured value ω_{g}. into the magnetic field. Then the derivation unit 112 derives, as the difference diff, the difference between the strength of the magnetic field m (μT) corresponding to the measured value m (μT) measured by the magnetic sensor 30 and the strength of the magnetic field m_{g} (μT) based on the measured value ω_{g} (rad/s) of the gyro sensor 40 (S104a). The strength of the magnetic field m is an example of the first value based on the measured value m. The procedure after this may be the same as the steps after S106 shown in FIG. 13.

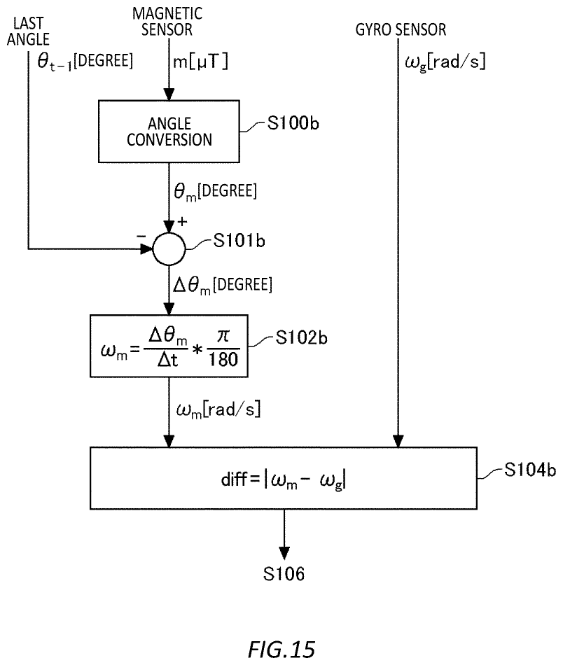

FIG. 15 is a flowchart showing another exemplary procedure performed by the derivation unit 112 for deriving the difference diff. This procedure is different from FIG. 13 and FIG. 14 as in FIG. 13 the unit of the difference diff is (degree) and in FIG. 14 the unit of the difference diff is the strength of the magnetic field (μT), while in FIG. 15 the unit of the difference diff is an angular velocity (rad/s). Note that the unit of the angular velocity may be angle/s rather than rad/s.

The derivation unit 112 converts the measured value m (μT) of the magnetic sensor 30 into the angle θₘ (degree) according to the reference table (S100b). Moreover, the derivation unit 112 derives Δθₘ (degree) by subtracting, from the angle θₘ (degree), the last angle θₜ₋₁ (degree) estimated by the estimation unit 114 (S101b). The derivation unit 112 derives the angular velocity ωₘ (rad/s) based on the measured value m of the magnetic sensor 30 by deriving (Δθₘ/Δt)×(π/180) (S102b). The angular velocity ωₘ is an example of the first value based on the measured value m.

In addition, the angular velocity ωₘ is an example of the first value based on a value based on an estimation result of the estimation unit 114. In addition, the angular velocity ωₘ is an example of the first value based on a value obtained by converting the measured value m into the angular velocity. In addition, the angular velocity ωₘ is an example of the first value based on a value obtained by converting the measured value m into an angle. Subsequently, the derivation unit 112 derives, as the difference diff, the difference between the angular velocity ωₘ (rad/s) based on the measured value m of the magnetic sensor 30 and the measured value (angular velocity) ω_{g} (rad/s) of the magnetic sensor 30 (S104b). The angular velocity ωₘ is an example of the second value based on the measured value ω_{g}. The procedure after this may be the same as the steps after S106 shown in FIG. 13.

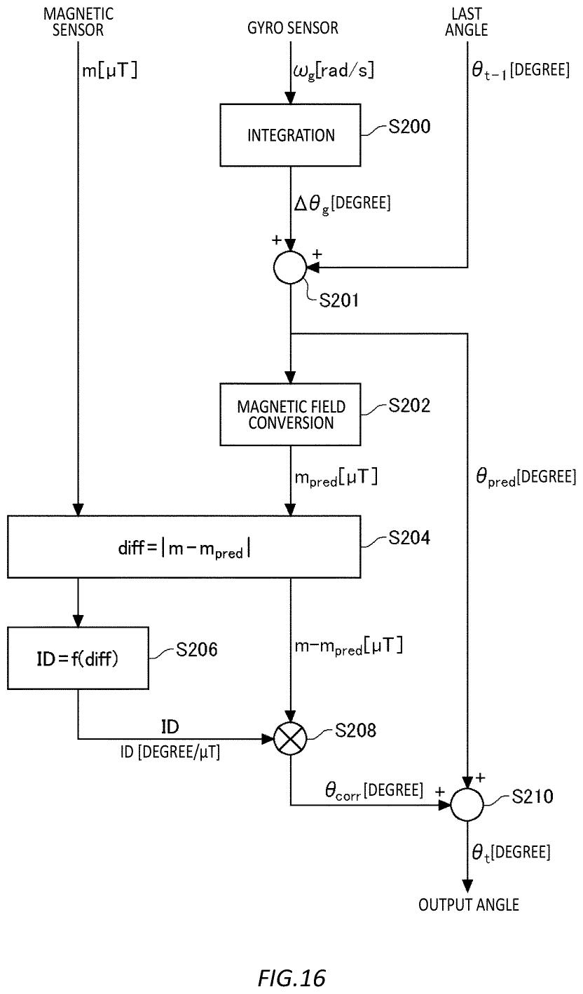

FIG. 16 is a flowchart showing another exemplary procedure performed by the estimation unit 114 for estimating an angle.

The derivation unit 112 derives an angle variation amount Δθ_{g} (degree) by integrating the measured value ω_{g} (rad/s) measured by the gyro sensor 40 (S200). The derivation unit 112 derives the predicted angle θ_{pred} (degree) based on the measured value ω_{g} of the gyro sensor 40 by adding the last angle θₜ₋₁ (degree) estimated by the estimation unit 114 to an angle variation amount Δθ_{g} (degree) obtained by integrating the measured value ω_{g} (rad/s) of the gyro sensor 40 (S201). Moreover, the derivation unit 112 converts the predicted angle θ_{pred} (degree) into the predicted strength of the magnetic field m_{pred} (μT) according to the reference table (S202). The strength of the magnetic field m_{pred} is an example of the second value based on the measured value ω_{g}. In addition, the strength of the magnetic field m_{pred} is an example of the second value based on a value obtained by integrating the measured value ω_{g}. In addition, the strength of the magnetic field m_{pred} is an example of the second value based on a value based on the estimation result by the estimation unit 114. In addition, the strength of the magnetic field m_{pred} is an example of the second value based on a value obtained by converting the measured value ω_{g} into the magnetic field. Then the derivation unit 112 derives, as the difference diff, the difference between the measured value m (μT) of the magnetic sensor 30 and the predicted strength of the magnetic field m_{pred} (μT) based on the measured value ω_{g} (rad/s) of the gyro sensor 40 (S204). The measured value m is an example of the first value based on the measured value m.

The derivation unit 112 derives, according to a predetermined function f(diff)=ID, a weight ID (degree/μT) for deriving a correction amount to correct the predicted angle θ_{pred} based on the difference diff (μT) (S206). ID is a real number. The derivation unit 112 derives the correction amount θ_{corr} (degree) by multiplying the difference diff (μT) by ID (degree/μT) (S208). The estimation unit 114 estimates the current angle θₜ (degree) of the second portion 12 relative to the first portion 11 by adding the correction amount θ_{corr} (degree) to the predicted angle θ_{pred} (degree) (S210) for correction. The predetermined function f(diff) is such a function that makes ID (degree/μT) smaller correspondingly as the difference diff becomes larger.

According to the above procedure, the estimation unit 114 corrects the predicted angle θ_{pred} based on the measured value ω_{g} of the magnetic sensor 30 with the correction amount θ_{corr} based on the magnitude of the difference diff to estimate the angle θₜ. Accordingly, the estimation unit 114 suppresses the influences of the hysteresis or the integration error by reducing, by the gyro sensor 40, the influence caused by the hysteresis of the magnetic field, and reducing, by the magnetic sensor 30, the influence of the integration error of the gyro sensor 40, allowing accurate estimation of the angle θₜ of the second portion 12 relative to the first portion 11.

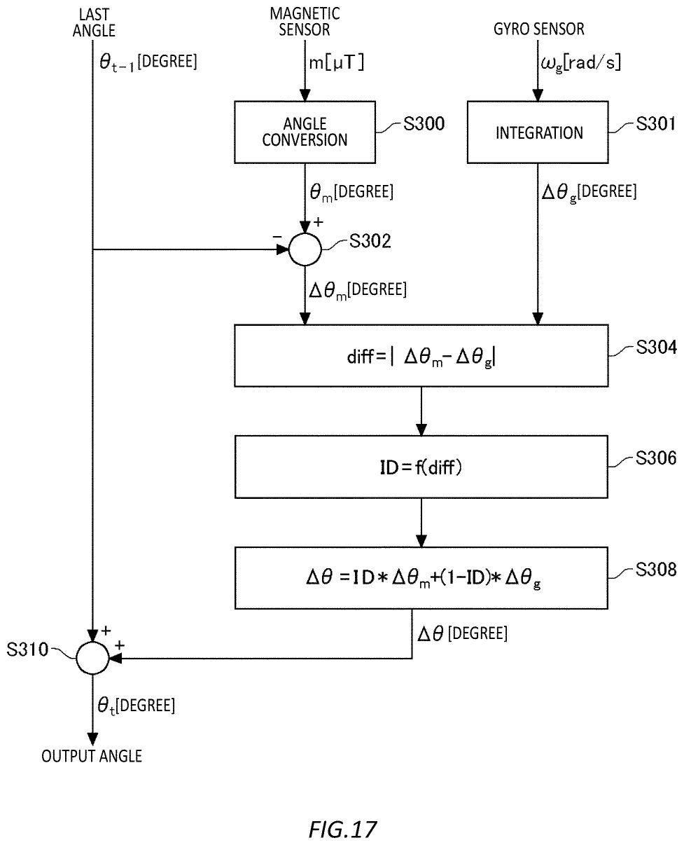

FIG. 17 is a flowchart showing another exemplary procedure performed by the estimation unit 114 for estimating an angle.

The derivation unit 112 converts the measured value m (μT) of the magnetic sensor 30 into the angle θₘ (degree) according to the reference table (S300). In addition, the derivation unit 112 derives an angle variation amount Δθ_{g} (degree) by integrating the measured value ω_{g} (rad/s) measured by the gyro sensor 40 (S301). The angle variation amount Δθ_{g} is an example of the second value based on the measured value ω_{g}. In addition, the angle variation amount ω_{g} is an example of the second value based on a value obtained by integrating the measured value ω_{g}. The derivation unit 112 derives angle variation amount Δθₘ (degree) based on the measured value m (degree) of the magnetic sensor 30 by subtracting, from the angle θₘ (degree), the last angle θₜ₋₁ (degree) estimated by the estimation unit 114 (S302). The variation amount Δθₘ is an example of the first value based on the measured value m. In addition, the variation amount Δθₘ is an example of the first value based on a value based on the estimation result by the estimation unit 114. In addition, the variation amount Δθₘ is an example of the first value based on a value obtained by converting the measured value m into an angular velocity. In addition, the variation amount Δθₘ is an example of the first value based on a value obtained by converting the measured value m into an angle. The derivation unit 112 calculates, as the difference diff, the difference between the angle variation amount Δθₘ (degree) based on the measured value m (μT) of the magnetic sensor 30 and angle variation amount Δθ_{g} (degree) obtained by integrating the measured value ω_{g} (rad/s) of the gyro sensor 40.

The derivation unit 112 derives the weight to derive the angle variation amount Δθ (degree) according to the predetermined function f (diff)=ID (S306). The estimation unit 114 derives the angle variation amount Δθ (degree) according to Δθ=ID×Δθₘ+(1−ID)×Δθ_{g} (S308). The predetermined function f (diff) is such a function that makes ID smaller correspondingly as the difference diff becomes larger. ID is a real number.

The estimation unit 114 estimates the current angle θₜ (degree) of the second portion 12 relative to the first portion 11 by adding the angle variation amount Δθ (degree) to the last angle θₜ₋₁ (degree) estimated from the angle θₘ (degree) by the estimation unit 114 (S310).

According to the above procedure, the estimation unit 114 estimates the angle θₜ by weighting, with a weight based on the difference diff, each of the angle variation amount Δθₘ based on the measured value m of the magnetic sensor 30 and the angle variation amount Δθ_{g} based on the measured value ω_{g} of the gyro sensor 40. Accordingly, the estimation unit 114 suppresses the influences of the hysteresis or the integration error by reducing, by the gyro sensor 40, the influence caused by the hysteresis of the magnetic field, and reducing, by the magnetic sensor 30, the influence of the integration error of the gyro sensor 40, allowing accurate estimation of the angle θₜ of the second portion 12 relative to the first portion 11.

Note that, the present embodiment describes the example in which the estimation unit 114 estimates the posture (angle) of the second portion 12 relative to the first portion 11. However, the estimation unit 114 may estimate a position of the second portion 12 relative to the first portion 11.

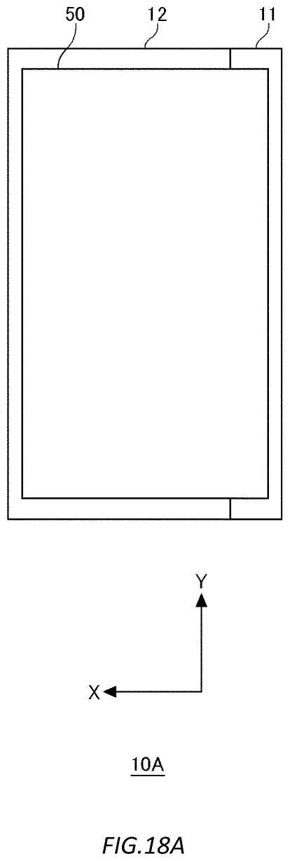

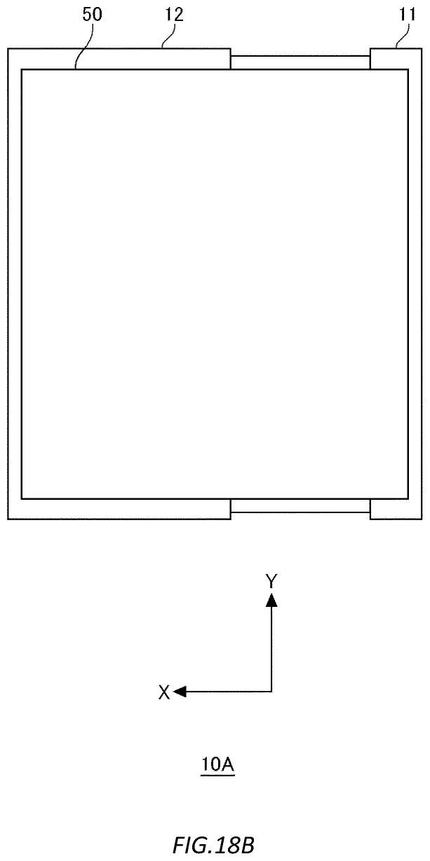

FIG. 18A and FIG. 18B show an exemplary apparatus 10A in which the estimation unit 114 estimates the position of the second portion 12 relative to the first portion 11. The apparatus 10A is a rollable smartphone in which a display screen of the display expands and contracts. The second portion 12 moves in the X axis direction relative to the first portion 11. The first portion and the second portion 12 may constitute the display unit. The second portion 12 may move relative to the first portion 11 from the first state (contracted state) shown in FIG. 18A to the second state (extended state) shown in FIG. 18B along the X axis direction. In this way, a width of the display screen 50 in the X direction expands and contracts. For example, the display screen 50 may be a thin display such as an organic EL display or the like which can be wound around a rotation axis along the Y axis.

In the case of such an apparatus 10A, the gyro sensor 40 may be provided on the rotation axis and rotated around the axis along the Y axis direction together with the rotation axis according to movement of the second portion 12 relative to the first portion 11 in the X axis direction.

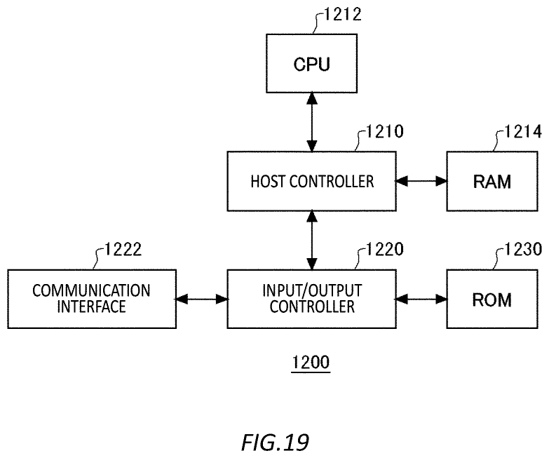

FIG. 19 shows an exemplary computer 1200 where a plurality of aspects of the present invention may be entirely or partially embodied. Programs installed in the computer 1200 can cause the computer 1200 to function as operations associated with the apparatus according to the embodiments of the present invention or one or more “units” of the apparatus. Alternatively, the programs can cause the computer 1200 to execute the operations or the one or more “units”. The programs can cause the computer 1200 to execute a process according to the embodiments of the present invention or steps of the process. Such programs may be executed by a CPU 1212 to cause the computer 1200 to perform specific operations associated with some or all of the blocks in the flowcharts and block diagrams described in the present specification.

The computer 1200 according to the present embodiment includes the CPU 1212 and an RAM 1214, which are mutually connected by a host controller 1210. The computer 1200 also includes a communication interface 1222 and an input/output unit, which are connected to the host controller 1210 via an input/output controller 1220. The computer 1200 also includes an ROM 1230. The CPU 1212 operates according to the programs stored in the ROM 1230 and the RAM 1214, thereby controlling each unit.

The communication interface 1222 communicates with other electronic devices via a network. A hard disk drive may store the programs and data used by the CPU 1212 in the computer 1200. The ROM 1230 stores therein boot programs or the like executed by the computer 1200 at the time of activation, and/or programs depending on hardware of the computer 1200. The program is provided via a computer readable storage medium such as a CD-ROM, a USB memory or an IC card or the network. The programs are installed on the RAM 1214, which also is an example of the computer readable storage medium, or the ROM 1230 and performed by the CPU 1212. Information processing written in these programs is read by the computer 1200, and provides cooperation between the programs and the various types of hardware resources described above. The apparatus or method may be configured by implementing operations or processings of information according to use of the computer 1200.

For example, in a case where a communication is performed between the computer 1200 and an external apparatus, the CPU 1212 may execute a communication program loaded in the RAM 1214 and instruct the communication interface 1222 to perform communication processing based on a process written in the communication program. Under the control of the CPU 1212, the communication interface 1222 reads transmission data which is stored in the RAM 1214 or a transmission buffer region which is provided in a storage media such as a USB memory, to transmit the read transmission data to the network or write the reception data received from the network into a reception buffer region or the like provided on the storage media.

Also, the CPU 1212 may cause the whole or required part of files which are stored in the external storage media (such as USB memory) or the database to be read by the RAM 1214, to perform a various type of processes for the data on the RAM 1214. Then, the CPU 1212 may write back the processed data to the external storage media.

A various type of information such as a various type of programs, data, tables and databases may be stored in a storage media to undergo an information processing. The CPU 1212 may execute, on the data read from the RAM 1214, various types of processing including various types of operations, information processing, conditional judgement, conditional branching, unconditional branching, information retrieval/replacement, or the like described throughout the present disclosure and specified by instruction sequences of the programs, to write the results back to the RAM 1214. Also, the CPU 1212 may retrieve information in the file, database or the like in the storage media. For example, when a plurality of entries each having an attribute value of the first attribute associated with an attribute value of the second attribute are stored in a storage media, the CPU 1212 may retrieve, among the plurality of entries, an entry whose attribute value of the first attribute is specified and matches the conditions and read the attribute value of the second attribute stored in the entry, thereby acquiring the attribute value of the second attribute associated with the first attribute which satisfies a predetermined condition.

The programs or software modules described above may be stored in a computer readable storage medium on or near the computer 1200. Also, a storage media such as a hard disk or a RAM provided in a server system which is connected to a dedicated communication network or the Internet is allowed to be used as a computer readable storage medium, thereby a program is provided in a computer 1200 via the network.

Computer readable medium may include any tangible apparatus that can store instructions for execution by a suitable apparatus. As a result, the computer readable medium having instructions stored therein includes an article of manufacture including instructions which can be executed to create means for performing operations specified in the flowcharts or block diagrams. Examples of the computer readable medium may include an electronic storage medium, a magnetic storage medium, an optical storage medium, an electromagnetic storage medium, a semiconductor storage medium, and the like. More specific examples of the computer readable medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-ray (registered trademark) disk, a memory stick, an integrated circuit card, and the like.

Computer-readable instructions may include either a source code or an object code written in any combination of one or more programming languages. The source code or the object code includes a conventional procedural programming language. The conventional procedural programming language may be assembler instructions, instruction-set-architecture (ISA) instructions, machine instructions, machine dependent instructions, microcode, firmware instructions, state-setting data, or an object-oriented programming language such as Smalltalk (registered trademark), JAVA (registered trademark), C++, etc., and programming languages, such as the “C” programming language or similar programming languages. Computer-readable instructions may be provided to a processor of a general-purpose computer, special purpose computer, or other programmable data processing apparatus, or to programmable circuitry, locally or via a local area network (LAN), a wide area network (WAN) such as the Internet, etc. The processor or the programmable circuitry may execute the computer readable instructions to create means for performing operations specified in the flowcharts or block diagrams. Examples of the processor include a computer processor, a processing unit, a microprocessor, a digital signal processor, a controller, a microcontroller, and the like.

While the present invention has been described with the embodiments, the technical scope of the present invention is not limited to the above-described embodiments. It is apparent to persons skilled in the art that various alterations and improvements can be added to the above-described embodiments. It is also apparent from description of the claims that the embodiments to which such alterations or improvements are made can be included in the technical scope of the present invention.

It should be noted that the operations, procedures, steps, stages, and the like of each process performed by an apparatus, system, program, and method shown in the claims, embodiments, or diagrams can be realized in any order as long as the order is not indicated by “prior to,” “before,” or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: terminal;
10A: apparatus;
11: first portion;
12: second portion;
14: display;
16: hinge mechanism;
18: rotation axis;
20: magnet unit;
30: magnetic sensor;
40: gyro sensor;
50: display screen;
50a, 50b: acceleration sensor;
100: estimation apparatus;
110: control unit;
112: derivation unit;
114: estimation unit;
120: storage unit;
130: communication I/F;
1200: computer;
1210: host controller;
1212: CPU;
1214: RAM;
1220: input/output controller;
1222: communication interface;
1230: ROM.

What is claimed is:

1. An estimation apparatus which estimates at least one of a position or a posture of a second portion relative to a first portion in an apparatus including the first portion, the second portion, a movable mechanism which causes at least one of a position or a posture of the second portion relative to the first portion to change, a magnetic sensor provided in one of the first portion or the second portion, a magnet unit which is provided in another of the first portion or the second portion and provides a magnetic field to be measured by the magnetic sensor, and a gyro sensor, the estimation apparatus comprising:
a derivation unit which derives a difference between a first value based on a first measured value according to a position or a posture of the second portion relative to the first portion measured by the magnetic sensor and a second value based on a second measured value according to a position or a posture of the second portion relative to the first portion measured by the gyro sensor; and
an estimation unit which estimates a position and a posture of the second portion relative to the first portion based on at least one of the first value or the second value and the difference.

2. The estimation apparatus according to claim 1, wherein
the estimation unit selects at least one of the first value or the second value based on the difference, and estimates a position and a posture of the second portion relative to the first portion based on the at least one of the first value or the second value selected.

3. The estimation apparatus according to claim 1, wherein the estimation unit
estimates a position and a posture of the second portion relative to the first portion based on the first value if the difference is smaller than a threshold, and
estimates a position and a posture of the second portion relative to the first portion based on the second value if the difference is equal to or more than the threshold.

4. The estimation apparatus according to claim 3, wherein
the estimation unit estimates a position and a posture of the second portion relative to the first portion based on a last estimation result and the second value if the difference is equal to or more than the threshold.

5. The estimation apparatus according to claim 1, wherein
the estimation unit estimates a position and a posture of the second portion relative to the first portion based on the first value having a first weight based on the difference and the second value having a second weight based on the difference.

6. The estimation apparatus according to claim 5, wherein
as the difference becomes larger, the first weight decreases and the second weight increases correspondingly.

7. The estimation apparatus according to claim 1, wherein
the estimation unit estimates a position and a posture of the second portion relative to the first portion based on the first value and relationship information indicating a relationship between a first value based on a first measured value measured by the magnetic sensor and a position or a posture of the second portion relative to the first portion if the difference is smaller than a threshold.

8. The estimation apparatus according to claim 3, wherein
if the difference is equal to or more than the threshold, the estimation unit continues estimation of a position and a posture of the second portion relative to the first portion based on the second value until a predetermined period elapses from a time point at which the estimation unit started estimation of a position and a posture of the second portion relative to the first portion based on the second value when the difference became equal to or larger than the threshold from a state of being smaller than the threshold, and if the difference remains equal to or more than the threshold after the predetermined period has elapsed from the time point, the estimation unit switches the estimation to estimation of a position and a posture of the second portion relative to the first portion based on the first value.

9. The estimation apparatus according to claim 1, wherein
the derivation unit derives a difference between the first value and the second value after converting a unit of the first value and a unit of the second value into a common unit.

10. The estimation apparatus according to claim 9, wherein
the unit is an angle, a magnetic flux density, an angle variation amount, a magnetic flux density variation amount, or an angular velocity.

11. The estimation apparatus according to claim 1, wherein
the first value is based on a value obtained by converting the first measured value into an angle or a value obtained by converting the first measured value into an angular velocity.

12. The estimation apparatus according to claim 1, wherein
the second value is based on a value obtained by converting the second measured value into an angle, a value obtained by converting the second measured value into a magnetic field, or a value obtained by converting a value obtained by converting the second measured value into an angle into a magnetic field, or a value obtained by integrating the second measured value.

13. The estimation apparatus according to claim 1, wherein
the first value or the second value is based on a value based on an estimation result by the estimation unit.

14. An estimation method for estimating at least one of a position or a posture of a second portion relative to a first portion in an apparatus including the first portion, the second portion, a movable mechanism which causes at least one of a position or a posture of the second portion relative to the first portion to change, a magnetic sensor provided in one of the first portion or the second portion, a magnet unit which is provided in another of the first portion or the second portion and provides a magnetic field to be measured by the magnetic sensor, and a gyro sensor, the estimation method comprising:
deriving a difference between a first value based on a first measured value according to a position or a posture of the second portion relative to the first portion measured by the magnetic sensor and a second value based on a second measured value according to a position or a posture of the second portion relative to the first portion measured by the gyro sensor; and
estimating a position and a posture of the second portion relative to the first portion based on at least one of the first value or the second value and the difference.

15. A computer readable medium storing therein a program that causes a computer to function as an estimation apparatus which estimates at least one of a position or a posture of a second portion relative to a first portion in an apparatus including the first portion, the second portion, a movable mechanism which causes at least one of a position or a posture of the second portion relative to the first portion to change, a magnetic sensor provided in one of the first portion or the second portion, a magnet unit which is provided in another of the first portion or the second portion and provides a magnetic field to be measured by the magnetic sensor, and a gyro sensor, the program causing the computer to perform:
deriving a difference between a first value based on a first measured value according to a position or a posture of the second portion relative to the first portion measured by the magnetic sensor and a second value based on a second measured value according to a position or a posture of the second portion relative to the first portion measured by the gyro sensor; and
estimating a position and a posture of the second portion relative to the first portion based on at least one of the first value or the second value and the difference.
